(19) United States
(12) Patent Application Publication
(10) Pub. No.: US 2013/0193677 A1
(43) Pub. Date: Aug. 1, 2013

(54) ASSEMBLY OF A CONTAINER AND A PLURALITY OF NOTE PADS

(71) Applicant: Erwin Frank Steginga, Amsterdam (NL)

(72) Inventor: Erwin Frank Steginga, Amsterdam (NL)

(73) Assignee: POSSIBILLION, Amsterdam (NL)

(21) Appl. No.: 13/638,819

(22) PCT Filed: Apr. 1, 2011
(86) PCT No.: PCT/EP2011/055096

§ 371 Date: Jan. 15, 2013

(30) Foreign Application Priority Data
Apr. 1, 2010 (EP) 10158939.8

(51) Int. Cl. B42D 5/00

(52) U.S. Cl. CPC B42D 5/005
USPC 281/44

(57) ABSTRACT

In an assembly of a container and at least a note pad the container contains a plurality of note pads having upper faces. The assembly comprises a fixing member for holding the note pads at a predefined location with respect to the container. The assembly is arranged such that the note pads can be mutually relocated in a direction extending parallel to the upper faces of the note pads.

### CROSS-REFERENCE TO RELATED APPLICATION

This application is a Section 371 National Stage Application of International Application PCT/EP2011/055096 filed Apr. 1, 2011 and published as WO/2011/121108 A1 in English.

### BACKGROUND

The discussion below is merely provided for general background information and is not intended to be used as an aid in determining the scope of the claimed subject matter.

Aspects of the invention relate to an assembly of a container and at least a note pad.

Such an assembly is known from JP 11-163994, which is related to a portable telephone which is provided with a memo paper fitting part in the main body thereof. This enables a user to record items during a telephone call. A disadvantage of the known assembly is that when several different items, messages, reminders or the like, are written down on the note pad it becomes difficult to keep an overview, for example quickly finding which item needs most attention.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An aspect of the invention is an assembly that includes a container containing a plurality of note pads having upper faces and a fixing member for holding the note pads at a predefined location with respect to the container. The assembly is arranged such that the note pads can be mutually relocated in a direction extending parallel to the upper faces of the note pads.

Due to this feature the user can change the positions of the note pads with respect to each other and the container which provides the opportunity to rearrange messages written on different note pads and laying the most relevant message at a location near an edge of the container, for example at a first position. The assembly is also typically useful for elderly people who can write down messages on different note pads and change the order of note pads with respect to the container. In one embodiment, the upper faces of the note pads lay in a horizontal plane such that the direction extending parallel to the upper faces of the note pads is also horizontal.

In practice the note pad may be of the stick-on type, which is also known as Post-it® Notes. At one side of the note-pad the edge is glued for bonding the sheets to each other. Each sheet of paper may be provided with a pressure-sensitive adhesive at a part of the bottom face of a sheet. It is conceivable that the bottom faces of the lowest sheets of paper of the note pads are also provided with adhesive which feature can be of use for sticking the note pads to the container. In such a case, this adhesive at least forms a part of the fixing member.

In a further embodiment, the container comprises a bottom which supports the note pads, and the fixing member comprises barriers for holding the note pads at a predefined position with respect to the bottom. The bottom may be flat such that in case of note pads having a similar thickness a substantially flat surface of sheets of papers of the different note pads is created.

The barriers may be formed by a continuous circumferentially edge enveloping the note pads, which edge is upwardly directed from the bottom. This means that the note pads can be positioned on the bottom within the circumferential edge. The bottom may be substantially free from obstacles. This allows the user to easily shift a note pad to an adjacent empty location from which a note pad had been removed earlier.

In one embodiment, the height of the edge is lower than the thickness of the note pads in order to easily grip an upper sheet of paper of the note pad or the entire note pad. The edge may be provided with recesses at the note pads in order to allow fingers of a user to reach the sides of the note pads.

The note pads may have similar sizes as seen from above, but different sizes are also conceivable.

In a specific embodiment the note pads have a rectangular shape and the container has a rectangular shape, wherein the longitudinal directions of the note pads are directed transversely with respect to the longitudinal direction of the container. This embodiment can be used by facing the narrowest edge of the container to the user such that elongate note pads are oriented transversely before the user. In this case the narrowest edge of the container is located the closest to the user and lies in front of the user.

The note pads may have different appearances, for example colors so as to further help the user to get organized.

In one embodiment, adjacent note pads contact each other, since this minimizes mutual shift of the note pads during writing down messages on the note pads. In fact, in this case adjacent note pads form part of the fixing member since adjacent note pads also hold each other at a fixed position with respect to the container.

In a specific embodiment the assembly is configured such that the note pads can be mutually relocated by taking out a note pad from the container and shift an adjacent note pad to the empty location. This means that the note pads are substantially free from adherence to the container.

### BRIEF DESCRIPTION OF THE DRAWINGS

Aspects of the invention will hereafter be elucidated with reference to the very schematic drawings showing embodiments of the invention by way of example.

FIG. 1 is a perspective view of an embodiment of the assembly.

FIG. 2 is a plan view of an alternative embodiment of the assembly.

FIGS. 3 and 4 are similar views as FIG. 2 of alternative embodiments.

FIG. 5 is a side view of an alternative embodiment of the assembly.

FIG. 6 is a similar view as FIG. 5 of another alternative embodiment.

### DETAILED DESCRIPTION OF THE ILLUSTRATIVE EMBODIMENTS

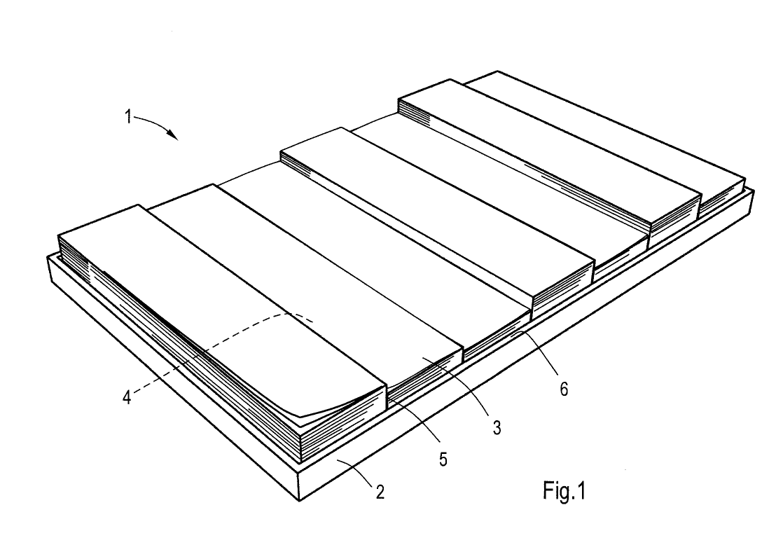

FIG. 1 shows a perspective view of an embodiment of an assembly 1. The assembly 1 as shown in FIG. 1 comprises a container 2 and seven note pads 3. The container 2 comprises a bottom 4 which supports the note pads 3. In this case the note pads 3 are of the stick-on type, in practice known as Post-it® Notes. At one side of the note pads 3 a note pad edge 5 is glued for bonding individual sheets of paper to each other. Each sheet of paper is provided with a pressure-sensitive adhesive at a part of the bottom face of a sheet adjacent to the note pad edge 5. In the embodiment of FIG. 1 the container 2 has a rectangular shape as seen from above, but alternative shapes and dimensions are conceivable. Of course, alternative shapes and number of note pads 3 are also conceivable.

The container 2 is provided with an edge 6, which protrudes upwardly from the bottom 4. The edge 6 forms a barrier for holding the note pads 3 at a predefined position with respect to the bottom 4. The note pads 3 fit within the edge 6 of the container 2 such that it envelopes the note pads 3. In other words, upon use of the assembly 1, the edge 6 prevents the note pads 3 from shifting out of the container 2 in a direction parallel to upper faces of the note pads 3, which is a horizontal direction when the upper faces of the note pads 3 lie within horizontal planes; this is often the case in practice. The height of the edge 6 is lower than the thickness of the note pads 3 such that a user can easily grasp the note pads 3 and the sheets of paper of the note pads 3.

The note pads 3 can be placed loosely in the container 2 such that the note pads 3 can be mutually relocated in a horizontal direction. This means that each note pad 3 is held at a fixed location with respect to the container 2 by means of the circumferential edge 6 and an adjacent note pad 3. Although adjacent note pads 3 may contact each other it is also possible that a small play exists between adjacent note pads 3 in order to facilitate taking out a note pad from the container 2. It is also conceivable that the note pads 3 slightly stick to the bottom 4 due to the presence of a pressure-sensitive adhesive at a bottom face of the lowermost sheet of paper of the note pads 3. The user can easily change the positions of the note pads 3 with respect to each other and the container 2 by taking out a note pad 3 from the container 2 and shift an adjacent note pads 3 to the empty location, for example. This provides the opportunity to rearrange messages written on different note pads 3 and laying the most relevant message at a location near an edge of the container 2 by means of relocating the note pads rather than taking the sheets of paper having a written message and sticking them to another object.

As shown in FIG. 1 the note pads 3 are rectangular as seen from above. All note pads 3 have similar sizes. However, alternative shapes and dimensions are conceivable.

The orientation of the container 2 and the note pads 3 in the embodiment of the assembly 1 according to FIG. 1 is such that the longitudinal direction of the note pads 3 are directed transversely with respect to the longitudinal direction of the container 2.

Furthermore, the sheets of paper of the different note pads 3 have different colors as illustrated by different patterns on the top sheets in FIG. 1. This may be helpful to attract the attention of the user immediately to a message written down on that note pad 3.

A lower face of the container 2 may be provided with resilient elements (not shown) such as rubber elements to create an anti-slip effect. This creates a sliding resistance between the container 2 and a surface on which the container 2 is placed and prevents the container 2 from displacing upon writing a message on the note pads 3.

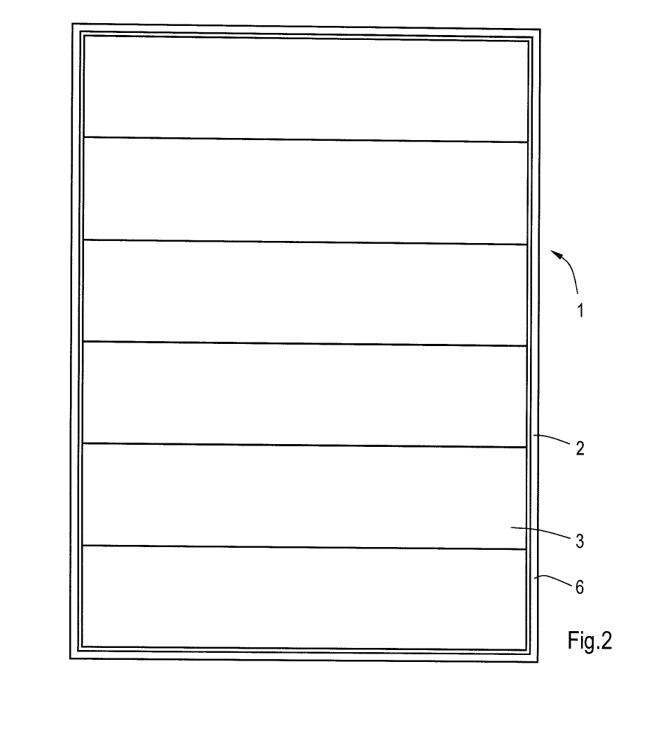

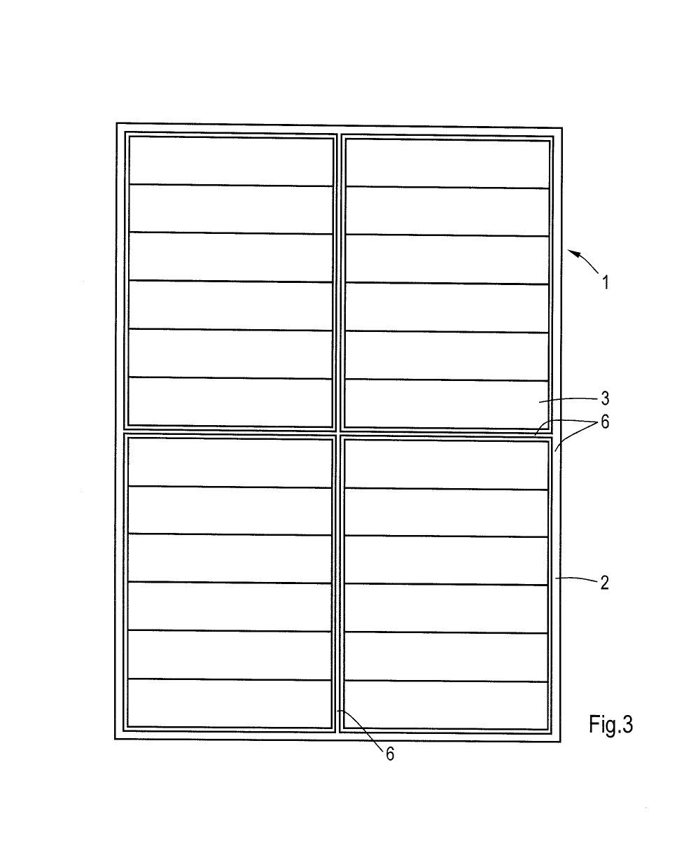

FIGS. 2-4 show alternative embodiments in which the number and dimensions of the note pads 3 are varied. FIGS. 3 and 4 illustrate that the container 2 may be provided with additional edges 6 protruding upwardly from the bottom 4 between opposite outer edges of the container 2.

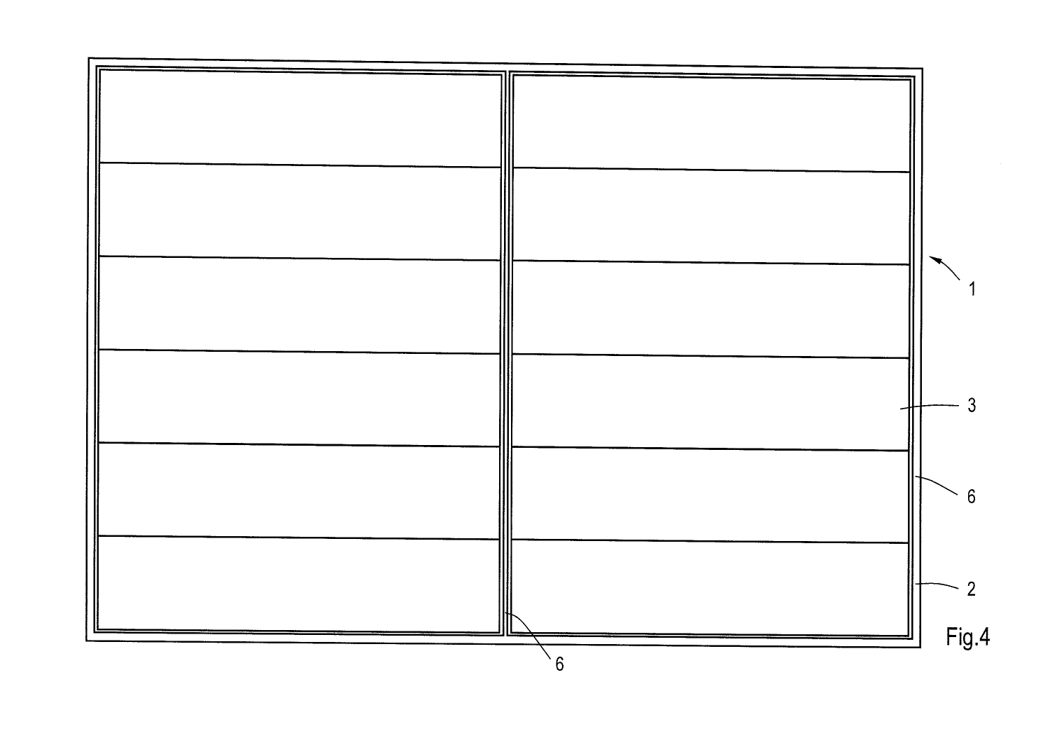

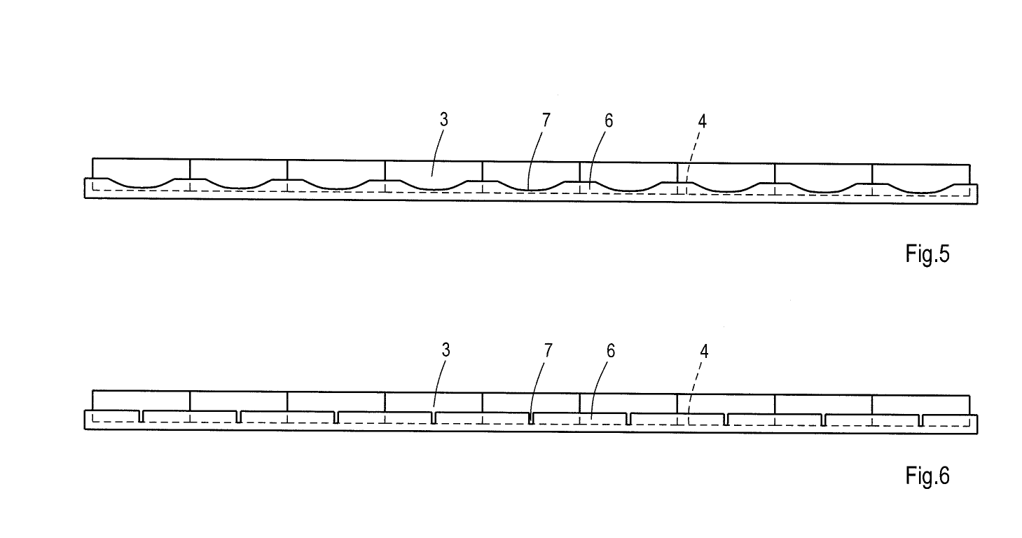

FIGS. 5 and 6 show different types of edges 6 of alternative embodiments. In these embodiments the edges 6 are provided with recesses 7 at the note pads 3 in order to allow fingers, in case of FIG. 5, or a sharp object, in case of FIG. 6, to take out a note pad 3 form the container 2. This is helpful when the thickness of the note-pad 3 has reduced due to use of sheets of papers. In one embodiment, the lowest locations or bottoms of the recesses 7 are lower than or substantially flush to the level of the bottom 4 of the container 2.

It is noted that the container 2 may be provided with a pen holder, as well.

The invention is not limited to the embodiments as described above and shown in the drawings, which can be varied in several ways without departing from the scope of the invention. It is conceivable, for example, that the note pads consist of sets of separate sheets of paper which sets are hold at a fixed location with respect to the container by the fixing member whereas uppermost sheets of papers can be relocated with respect to each other.

1. An assembly of a container and at least a note pad, wherein the container contains a plurality of note pads having upper faces and a fixing member for holding the note pads at a predefined location with respect to the container, wherein the assembly is configured such that the note pads can be mutually relocated in a direction extending parallel to the upper faces of the note pads.

2. The assembly according to claim 1, wherein the container comprises a bottom which supports the note pads and wherein the fixing member comprises barriers for holding the note pads at a predefined position with respect to the bottom.

3. The assembly according to claim 2, wherein the barriers are formed by a continuous circumferentially edge enveloping the note pads, which edge is upwardly directed from the bottom.

4. The assembly according to claim 3, wherein the height of the edge is lower than the thickness of the note pads.

5. The assembly according to claim 1, wherein the note pads have similar sizes.

6. The assembly according to claim 1, wherein the note pads have a rectangular shape.

7. The assembly according to claim 1, wherein the container has a rectangular shape.

8. The assembly according to claim 6, wherein longitudinal directions of the note pads are directed transversely with respect to a longitudinal direction of the container.

9. The assembly according to claim 1, wherein the note pads have different appearances.

10. The assembly according to claim 1, wherein adjacent note pads contact each other.

11. The assembly according to claim 1, wherein the container is provided with a anti-slip portions configured to create a sliding resistance between the container and a surface which supports the container.

12. The assembly according to claim 11, wherein the anti-slip portions comprise resilient elements provided at a lower surface of the container.

13. The assembly according to claim 3, wherein the edge is provided with recesses at the note pads.

14. The assembly according to claim 13, wherein lowest surfaces of the recesses are substantially flush to the bottom.

15. The assembly according to claim 1, wherein the assembly is configured such that the note pads are mutually relocated by taking out a note pad from the container and shifting an adjacent note pad to the empty location.

16. The assembly according to claim 3, wherein the bottom is substantially free from obstacles.
